(19) United States
(12) Patent Application Publication
(10) Pub. No.: US 2003/0147126 A1
(43) Pub. Date: Aug. 7, 2003

(54) Method and device for regulating a medium with an amplifying effect, especially a fiber optical waveguide

(76) Inventor: Lutz Rapp, Deisenhofen (DE)

Correspondence Address: BELL, BOYD & LLOYD, LLC, P. O. BOX 1135, CHICAGO, IL, 60690-1135, US

(21) Appl. No.: 10/257,710

(22) PCT Filed: Jan. 11, 2001
(86) PCT No.: PCT/DE01/00094

(30) Foreign Application Priority Data
Apr. 13, 2000 (DE) 100183573

(51) Int. Cl. H01S 3/00

(52) U.S. Cl. 359/341.41

(57) ABSTRACT

The invention relates to a method and a device for regulating the optical amplification of a medium with an amplifying effect, especially a doped fiber optical waveguide. The intensity of the amplified spontaneous emission is used as a regulating variable for the amplification power, especially the power of a pump laser.

The invention relates to a method for controlling a gain of a medium, with an amplifying effect, in an optical data transmission system that is fed energy on an optical or electrical path, and effects an amplification of a light signal that traverses the medium. The invention also relates to devices for carrying out the abovenamed method.

Digital and also analog data are increasingly being transmitted in the form of optical data signals in glass fiber lines over great distances. This requires the light signals, which suffer a loss in intensity in the course of their transmission path, to be reamplified at regular spacings. Such an amplification can be performed, for example, by electronic readout of the signals, subsequent regeneration of the optical signals and feeding of these signals into a further transmission path. However, there is also the possibility of achieving the gain by a purely optical amplification, for example by means of so-called optical amplifiers, which can also be remotely pumped.

Such a data transmission path with a remotely pumped optical power amplifier is disclosed in the patent application DE 196 22 012 A1 of the applicant. Shown in this application is an optical data transmission path that comprises sections with passive transmission fibers and remotely pumped, distributed optical amplifiers connected therebetween, these optical amplifiers being constructed on the basis of active fibers that are doped in a known way with ions of elements from the group of the rare earths, and draw their amplification energy via a pumping light source. The disclosure content of the above-cited patent application, and of the IEEE Photonics Technology Letters, VOL. 7, No. 3, March 1995, pp. 333-335, cited therein, is hereby taken over in full.

A problem of such optical amplifiers resides in that they superimpose a noise spectrum on the information-carrying light waves. The noise components thus generated likewise experience an amplification in downstream amplifiers. In order to obtain the same signal quality for all channels, the same signal-to-noise power ratio should be present at the end of the transmission path for all wavelength channels. Furthermore, nonlinear effects in the glass fibers limit the maximum permissible channel powers. Consequently, there is an optimum operating state of the transmission path. In order to operate the path as near as possible to its optimum operating state, it is necessary to control the optical amplifiers as accurately as possible. Uncontrolled amplification of the light signals can cause the transmission quality to be negatively influenced, and the error rate of the digital signals to rise.

It is therefore an object of the invention to find a method and a device for controlling the amplification of optical data transmission signals which permit a clearly more accurate control of the amplifier gain by comparison with the prior art.

This object is achieved by means of the independent patent claims.

The inventor has recognized that a substantial problem in the optical power amplification of data transmission signals resides in the fact that it is neither the actual launched power of the pump laser nor the actual amplification or the gain—which would be even better—that is measured for controlling the power of the pump lasers used for the amplification, but only the power of the pump laser. This is generally performed by splitting off a portion of the pumping laser light before the launching into the fiber, and measuring it via a photodiode. There is between the measuring signal and the pump power actually injected into the fiber a nonlinear relationship that depends on further influencing quantities, for example the temperature. This relationship can also be varied by aging effects. Furthermore, the gain achieved in the case of a given pump power also depends on the power of the signals and their wavelength. Consequently, the power injected into the doped fiber can be determined only inaccurately with the aid of the measuring signal obtained.

A remedy can be provided, when controlling the power, by no longer measuring the power of the pumping laser light itself, which is actually uninteresting, but determining the actual gain, and by using the actual gain of the pump lasers to control its power. An impairment of the control owing to disturbing influences such as, for example, temperature changes or aging is thereby avoided.

In the case of so-called pumped optical power amplifiers, use is made of the physical property of doped optical conductors that electrons, excited by the light of the pump laser, are raised to higher energy levels from where they, excited by the light used for the data transmission, fall back again into their original energy level, dissipate their energy in so doing and amplify the data-transmitting light in this way. However, for the electrons that have been raised to higher energy levels there is also the possibility of randomly falling back with a certain time constant or a certain probability into the original level and emitting a noise signal in so doing. This process is known to be designated as amplified spontaneous emission (ASE). Typically, there are also no preferred propagation directions for this stochastically produced signal, and so the ASE advances both in the forward and in the backward direction of the data transmission path. Since the optical power amplifier amplifies any light traversing it, the amplified spontaneous emission (ASE) is also correspondingly amplified and can therefore serve as a measure of the actual gain of a light signal.

Thus, according to the invention, the actual gain is measured with the aid of the intensity of the amplified spontaneous emission (ASE), and the power of the pump laser can be adjusted such that the gain of the data signals exhibits a required value.

In order to determine the ASE, it is possible, for example, to use the fact that this also propagates against the actual direction of data transmission, or it is possible to measure the intensity of the amplification at a wavelength that is free from data to be transmitted, and so it is therefore also possible to determine the pure ASE power here.

If, on the other hand, it is known which actual gain should be reached by a specific setting of a pump laser, this direct measurement of the gain via the ASE power can also be used in order to reach conclusions on aging processes or other faults occurring in the data transmission path.

It is to be mentioned, furthermore, that the method according to the invention can be used not only with fiber amplifiers, but also with waveguide structures in the substrate, and also with semiconductor amplifiers, the latter being pumped not with light, but electrically.

In accordance with this fundamental idea of the invention, the inventor proposes to improve a method for controlling an optical gain of a medium, with an amplifying effect, in an optical data transmission system that is fed energy on an optical or electrical path, and which effects an amplification of a light signal that traverses the medium, the improvement being performed to the effect that the intensity of an amplified spontaneous emission in the medium is detected, and a procedure that is related to the gain of the medium or to the structure containing the latter is initiated as a function of this intensity.

As mentioned above, the medium with an amplifying effect can be, for example, an optical conductor, a waveguide structure in the substrate or a semiconductor amplifier, the optical conductor preferably being an optical fiber, and the medium with an amplifying effect preferably being doped with elements of the group of rare earths, preferably with erbium.

In accordance with an advantageous refinement of the method according to the invention, it is proposed that forward-directed and/or backward-directed light is coupled out upon detection of the amplified spontaneous emission (ASE), it being possible as a result to determine the gain quantitatively. The outcoupling of the backward-directed light can be performed, for example, with the aid of a circulator or an isolator.

According to the invention, it is also possible upon detection of the amplified spontaneous emission (ASE) to undertake a frequency-dependent division of the forward-and/or backward-directed light into at least two frequency bands, and measurement of the intensity in at least one frequency band that is preferably free from data signals. It is obvious for this purpose to modify the ASE suppression filters, often already built into optical amplifiers, in such a way that the suppressed ASE can be detected with the aid of a photodiode.

The energy can preferably be supplied on an optical path by a pumping laser light with a wavelength in the vicinity of 980 nm and/or 1480 nm.

In accordance with the idea of the invention, the initiated procedure can be a control mechanism for the energy supplied, in particular for the power of a pumping laser, the proposed method preferably being used for the control of 980 nm lasers.

In a further preferred embodiment of the invention, the dependence between the actual gain of a signal and the intensity of the amplified spontaneous emission (ASE) is firstly measured, for example, in a test set-up, in order to determine the gain present, and this dependence is subsequently stored by an appropriate mathematical function or a table, and is used in the determination of the gain actually present.

As already mentioned above, the initiated procedure can be a monitoring mechanism for the reliability performance of an amplifier device or an amplification path, an alarm being raised in the case of a variation in the gain above and/or below a threshold value as a function of the energy supplied and the signal power.

Furthermore, according to the invention the measured variables (signal powers and/or signal wavelengths and/or temperature) can be used to determine the pump power output by individual pump lasers, in order to detect variations in the performance data of the pump lasers.

Likewise, the measured ASE power can be used to determine the noise figure of an amplifier device, in order to determine the noise figure its dependence on the amplified spontaneous emission (ASE) and, if appropriate, further parameters (for example the temperature) being stored by one or more functions and/or tables.

The abovenamed method can be carried out according to the invention with the aid of a computer or microprocessor, with an appropriate computer program with program means being used in order to execute the steps in accordance with the previously described method when the program is run on a computer or microprocessor.

According to the invention, an optical isolator (=optical diode) that has a means for detecting the backward-directed light can serve for detecting the amplified spontaneous emission in a data transmission and/or amplification path, having an input, an output and means, arranged therebetween, that are suitable, inter alia, to couple out backward-directed light.

This optical isolator can be configured according to the invention in such a way that the means arranged between the input and output effect an expansion of the light beam, light running from the input to the output being focused onto the output, while light running from the output to the input is not focused onto the input.

Furthermore, the means arranged between the input and output can include two GRIN lenses with an arrangement, lying therebetween, consisting of two polarizers and a Faraday rotator. The term polarizer is understood below as a component or a material in which the propagation properties of the light depend on the state of polarization.

The means for detecting the backward-directed light in the optical isolator according to the invention can be a photodiode, for example.

According to the invention, it is also proposed to improve an arrangement for detecting an amplified spontaneous emission (ASE) in an optical data transmission and/or amplification path, having an input and an output for light with optical data signals to be transmitted, to the effect that at least one frequency divider and a detector are provided between the input and output, at least one frequency range without data signals being coupled out and supplied to a detector.

In accordance with the abovedescribed method according to the invention, the inventor also proposes an optical data transmission path that includes the means for carrying out this described method.

Further features of the invention emerge from the claims and the following description of the exemplary embodiments with reference to the drawings.

The invention is explained in more detail below with the aid of the drawings, in which:

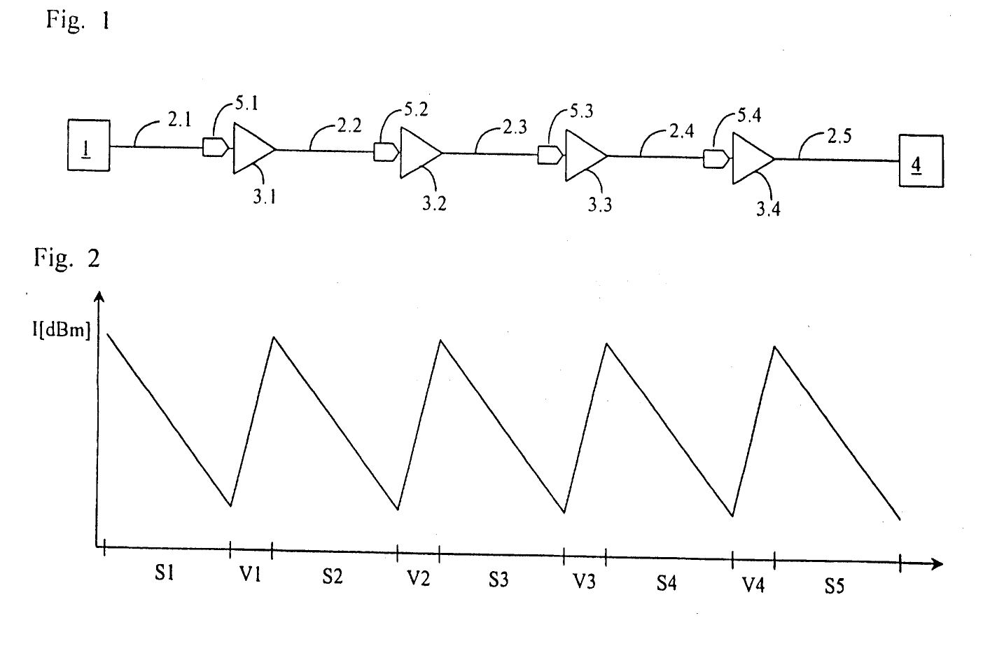

FIG. 1 shows a data transmission path;

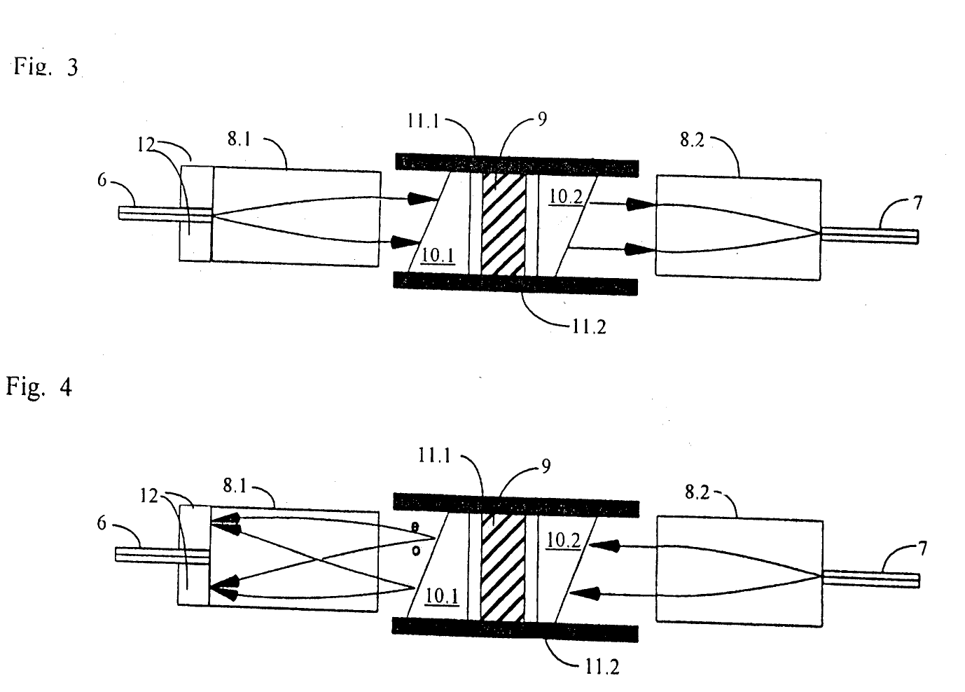

FIG. 2 shows the intensity profile of the light over the data transmission path;

FIG. 3 shows an optical isolator, with an illustration of the propagation of light in the signal direction;

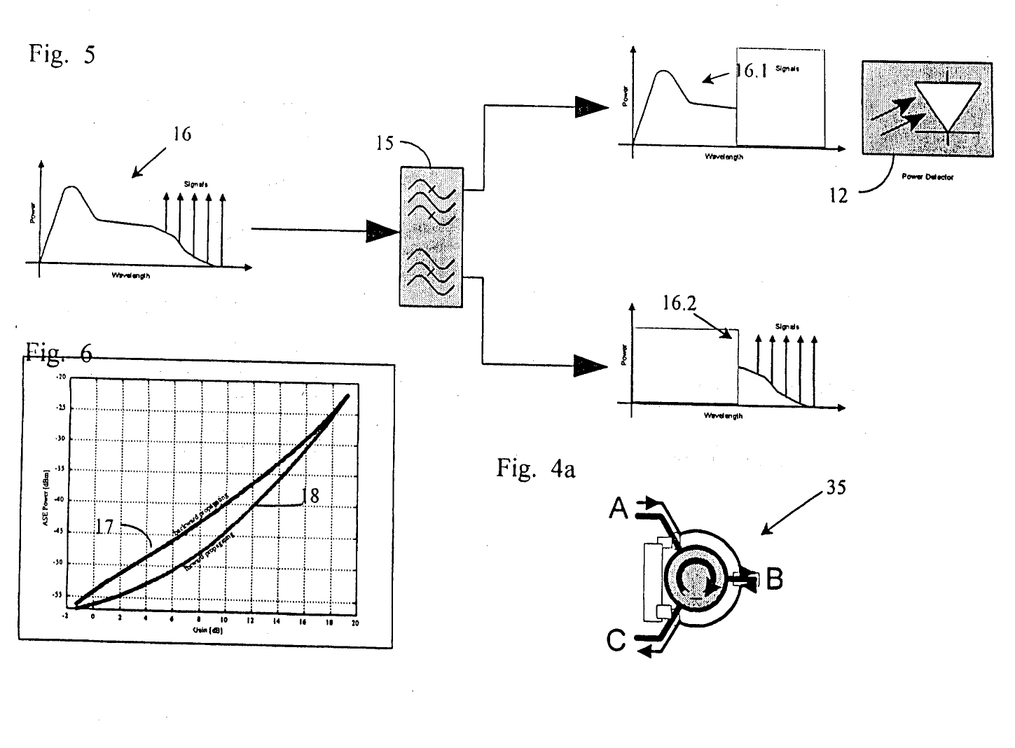

FIG. 4 shows the optical isolator with an illustration of the propagation of light counter to the signal direction;

FIG. 4a shows an optical circulator;

FIG. 5 shows coupling out in the data transmission path of the non-signaling light spectrum;

FIG. 6 shows an illustration of the functional relationship between the ASE intensity and the gain actually transmitted to the signal;

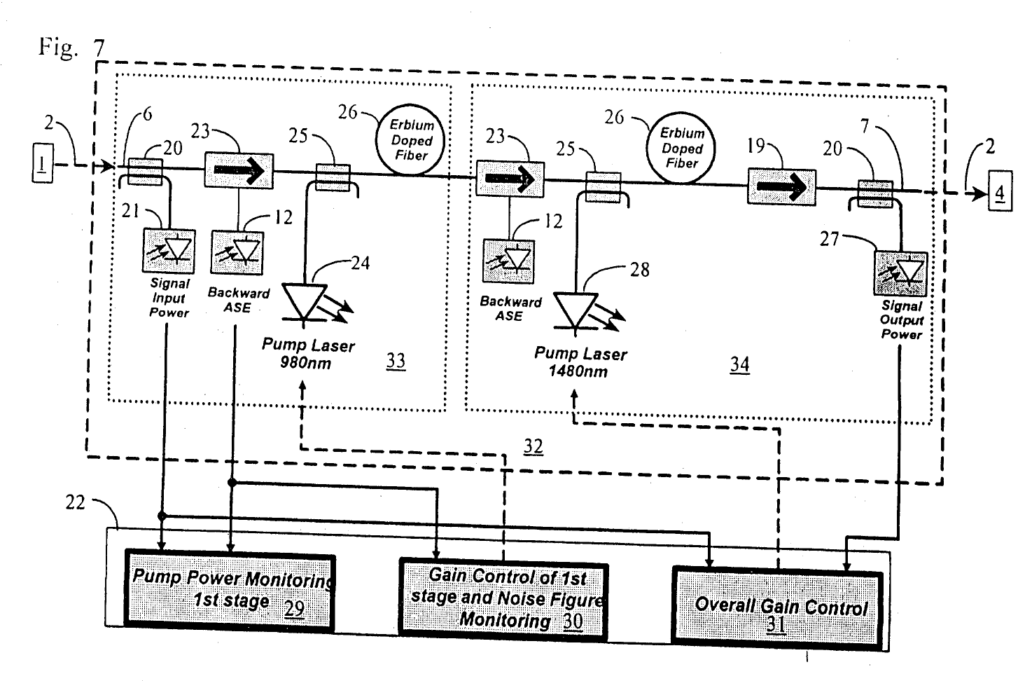

FIG. 7 shows a schematic of a data transmission path having a multistage amplifier with control of the pump laser power via the measurement of the backward-directed ASE intensity.

FIG. 1 shows an optical data transmission path according to the invention from a transmitter 1 to a receiver 4, having the subsections 2.1 and 2.5 and power amplifiers 3.1 to 3.4 connected therebetween.

In FIG. 2 thereunder, there is illustrated correspondingly in a diagram the intensity profile of the optical signal referred to the path sections S1 to S5 indicated therebelow, with amplification paths V1 to V4 situated therebetween. It is to be seen from the figure how the intensity of the data signal falls monotonically in the individual path sections and is reamplified over the amplification path, after which it falls again in the segment, following thereupon, of the transmission path until the signal finally passes from the receiver to the transmitter.

According to the invention, the amplification paths V1 to V4 and the power amplifiers 3.1 to 3.4 can, for example, be an optical fiber doped with erbium that is supplied with energy with the aid of a pump laser. Collected in each case upstream on the input side to the power amplifiers 3.1 to 3.4 is a detector according to the invention for the purpose of measuring the backward-propagating amplified spontaneous emission 5.1 to 5.4. This can, for example, be an optical isolator known per se in the case of which a detector for measuring the backward-directed light is additionally fitted.

Such an optical isolator according to the invention is illustrated in FIGS. 3 and 4, FIG. 3 depicting the forward direction of the light by the arrows, and FIG. 4 depicting the backward direction of the transmitted light by the arrows.

The optical isolators comprise an input 6, into which the light enters, and an output 7 from which the light re-enters the data transmission path. A GRIN lens (GRIN=gradient-index) is located in each case on the input side and output side. Located between the two GRIN lenses is a Faraday rotator 9, which is formed by two magnets 11.1 and 11.2 and a substance normally not optically active, and is surrounded by polarizers 10.1 and 10.2 on the input and output sides, respectively.

The arrows in FIG. 3 show how the entering light on the input side is aligned with the first polarizer 10.1. A rotation of the polarization by 45° about the two axes of polarization takes place in the Faraday rotator 9. The light is subsequently recombined again in the GRIN lens on the output side and led to the output 7.

As FIG. 4 shows, light entering counter to the direction of data transmission, which enters the optical isolator from the output 7, is likewise firstly directed onto the second polarizer, guided through the two polarizers and the Faraday rotator situated therebetween, although this backward-directed light is no longer collimated in the GRIN lens on the input side onto the fiber on the input side, but continues to propagate divergently and in this way strikes the detector that is arranged on the input side and surrounds the incoming fiber here, and opens up there the possibility of measuring the backward-directed light, and thus the amplified spontaneous emission (ASE).

In addition to the illustrated situation of a directly fitted detector, it is, of course, also possible for the backward-directed light to be guided further via an optical fiber to a remotely arranged detector.

Instead of an isolator, it is also possible to use a circulator 35, as is shown in FIG. 4a. Light that is launched at the port A leaves the circulator 35 at the port B, while light launched at the port B leaves the circulator 35 at the port C. In the present application, the signals thus traverse the circulator 35 in the direction of data transmission from port A to port B, while the backward ASE can be detected at port C, for example by a photodiode.

A circulator offers the same insertion loss for the paths from port A to port B and from port B to port C, as a result of which its design is more complex by comparison with an isolator. Consequently, the insertion loss turns out to be higher than in the case of an isolator, and this has a negative effect on the noise figure. An isolator is therefore to be given preference.

A further arrangement for measuring the ASE is illustrated in FIG. 5. Here, there is interposed in the optical data transmission path a filter 15 into which the entire spectrum 16 of the optical signal runs and is selectively split into two spectral regions 16.1 and 16.2. The first, coupled-out spectral region 16.1 is free from digital signals and therefore includes only at least a part of the noise of the total signal. The intensity of this portion of the spectrum 16.1 is subsequently measured via a detector 12 (a photodiode here). The partial spectrum 16.2 of the data transmission signal that is not coupled out continues to be held on the data transmission line and is guided in the direction of the receiver.

Since the spectral portion 16.1 of the data signal is free from frequencies via which the actual digital signal are transmitted, the intensity of this portion forms a measure of the amplified spontaneous emission (ASE) in the data transmission path.

Overall, therefore, FIGS. 3 and 4 illustrate a device with the aid of which the backward-directed intensity of the ASE in the data transmission path can be measured, while the device in accordance with FIG. 5 opens up a possibility of measuring the ASE in the data transmission path that propagates in the direction of transmission of the data signal.

In order to demonstrate that it really is possible on the basis of measuring the intensity of the ASE to reach a conclusion on the actual gain of a medium with an amplifying effect, in particular a sorted optical fiber or an optical substrate, FIG. 6 shows a diagram of the empirically measured relationship between the intensity of the measured ASE (X-axis) and the gain of a signal passing through (Y-axis). The line 17 represents the intensity of the backward ASE as a function of the gain actually present in an optical fiber doped with erbium, while the line 18 lying therebelow exhibits the measured intensity of the ASE in the forward direction as a function of the actual amplification, that is to say of the actual gain in the data signals, in an optical fiber doped with erbium (EDFA).

The line 17 shows a virtually linear profile over a range of intensity that is still almost 35 dB, while the line 18 exhibits a slightly quadratic functional relationship. Both lines rise in a strictly monotonic fashion, such that the measurement of the value of the intensity of the ASE permits an unambiguous conclusion on the gain actually present. The relationship between the measured intensity of the ASE and the gain present can be stored with the aid of functions or in tabular form, such that the measured intensity of the ASE for the data-carrying light can be used to reach a direct conclusion on the effectiveness of the present amplification.

It is thus possible on the basis of this relationship to carry out control of the pump laser or of a supply of electrical energy to a medium with an amplifying effect in order to avoid the use of an excessively low gain which would cause a raising of the noise figure, or else to avoid using an excessively high gain, resulting in nonlinear effects in the fiber leading to strong signal distortions.

Finally, FIG. 7 is a schematic of an optical data transmission path 2 having the internal design of a multistage optical amplifier 32 with a first amplifier stage 33 (980 nm) and a second amplifier stage 34 (1480 nm). This example shows the combination of the proposed control method in the first amplifier stage 32 with the already known control method in the second amplifier stage 34. In the first stage 32 of the amplifier, a small portion of the incoming signal from the data transmission path 2 is coupled out with the aid of a coupler 20, and guided to a signal power detector 21 in order to measure the strength of the incoming signal. The remainder of the transmitted light is guided to an optical isolator 23 according to the invention, whose design is illustrated by way of example in FIGS. 3 and 4. Here, the backward-directed ASE power generated in this stage is measured by the detector 12, and a further coupler 25 follows subsequently for launching the light from a pump laser with a 980 nm wavelength. The pump laser 24 is controlled via the computer 22, the measured backward-directed ASE power being used as controlled variable, and the intensity of the pump laser 24 being set in accordance with a stored function or a stored table in dependence on the ASE power such that an optimum gain of the data signals is set up in the first fiber 26 doped with erbium (EDF).

An optical isolator 23 with detector 12 again subsequently follows the EDF 26 and is used to measure the backward ASE. Finally, the data signal is directed via a coupler 25 via which a pump laser with 1480 nm feeds the subsequent fiber 26, which is doped with erbium. Following this is an isolator 19, known in the prior art, with a downstream decoupler 20 via which a component signal is coupled out and the intensity of the signal at the end of the data transmission path is measured in the signal output power detector 27. The information relating to this intensity is likewise fed to the computer, so that the pump laser 28 can be controlled via it. However, there is also the alternative possibility of detecting the measured backward-directed ASE power measured upstream of the last coupler 25, and of using this information to control the pump laser 28.

The processor 22 is subdivided functionally into three task areas. The function block 30 has the task of controlling the pump power of the pump laser 24. The measured backward ASE is evaluated for this purpose. This measured variable also permits the noise figure of the first stage to be determined. Since the noise figure of the overall arrangement is definitively determined by the first stage, that of the overall arrangement is also known.

The function block 29 serves the purpose of monitoring the power data of the pump laser 24. It is known on the basis of measurements that have been carried out at the instant of commissioning how large the pump power or the current injected into the laser diode must be in order to attain the gain determined from the measured backward-directed ASE power in conjunction with the measured input power. In order to improve the measurement, the input power can be measured in a spectrally resolved fashion, or the distribution of the input power can be derived from the measured powers at the transmitters. If the actually injected pump power and the injection current actually fed to the laser diode deviate from this value, there has been a change in the performance data of the pump laser 24. It is possible in this way to detect aging effects, for example.

The second amplifier stage can also be controlled in the same way. However, the aim below is to describe how the proposed control concept is rationally combined with a further control method. The aim of the amplifier control is to set a prescribed gain in conjunction with the lowest possible noise figure. The optimum gain of the first amplifier stage is set by means of the already described control of the pump power of the pump laser 24, and the noise figure of the overall arrangement is obtained. The function block 31 is now used to set the pump power of the pump laser 28 so as to produce the desired gain in the overall arrangement from the input 6 up to the output 7.

It may be pointed out in a supplementary fashion that the term laser covers all light sources that are suitable for making pumping light available, in particular also including laser diodes and semiconductor lasers. It is also to be noted that the method according to the invention can be used both in one stage and in several stages in a data transmission path.

It goes without saying that the abovenamed features of the invention can be used not only in the respectively specified combination, but also in other combinations or standing alone, without departing from the scope of the invention.

Thus, in summary the invention makes available a method and a device for controlling the optical gain of a medium with an amplifying effect, in particular a doped optical fiber, the intensity of the amplified spontaneous emission being used as controlled variable for the gain, in particular of the power of a pump laser, and there being an avoidance of amplification of digital signals in the saturation region. A particular resulting achievement is that the maximum signal-to-noise power ratio is attained or dropped below only slightly, and that the transmitted data are prevented from being affected by noise despite the occurrence of multiple sequential amplification of a data transmission signal.

1. A method for controlling an optical gain of a medium (26), with an amplifying effect, in an optical data transmission system that is fed energy on an optical or electrical path, and which effects an amplification of a light signal that traverses the medium, characterized in that the intensity of an amplified spontaneous emission (ASE) of light in the medium (26) is detected, and a procedure that is related to the gain of the medium (26) or to the structure containing the latter is initiated as a function of this intensity.

2. The method as claimed in the preceding claim 1, characterized in that an optical conductor (26) or a semiconductor amplifier is used as the medium with an amplifying effect.

3. The method as claimed in the preceding claim 2, characterized in that the optical conductor is an optical fiber (26) or a waveguide structure on a substrate.

4. The method as claimed in one of the preceding claims 1 to 3, characterized in that the medium (26) with an amplifying effect is doped with rare earths, preferably with erbium.

5. The method as claimed in one of the preceding claims 1 to 4, characterized in that forward-directed and/or backward-directed light is coupled out upon detection of the amplified spontaneous emission (ASE).

6. The method as claimed in one of the preceding claims 1 to 5, characterized in that the backward-directed light is coupled out with the aid of a circulator (35) or an isolator (23).

7. The method as claimed in one of the preceding claims 1 to 4, characterized in that upon detection of the amplified spontaneous emission (ASE) a frequency-dependent division of the forward- and/or backward-directed light into at least two frequency bands (14.1, 14.2) and measurement of the intensity in at least one frequency band (14.1) that is preferably free from data signals are undertaken.

8. The method as claimed in one of the preceding claims 1 to 7, characterized in that pumping laser light at a wavelength in the vicinity of 980 nm and/or 1480 nm is used for the energy supply.

9. The method as claimed in one of the preceding claims 1 to 8, characterized in that the initiated procedure is a control mechanism for the energy supplied.

10. The method as claimed in one of the preceding claims 1 to 9, characterized in that the initiated procedure is a control mechanism for the power of a pumping laser, preferably a 980 nm laser (24).

11. The method as claimed in one of the preceding claims 1 to 10, characterized in that the dependence between actual gain and intensity of the ASE is stored by a function or a table and used in order to determine the gain present.

12. The method as claimed in one of the preceding claims 1 to 11, characterized in that the initiated procedure is a monitoring mechanism for the reliability performance of an amplifier device or an amplification path.

13. The method as claimed in one of the preceding claims 1 to 12, characterized in that an alarm is raised in the case of a variation in the gain above and/or below a threshold value as a function of the energy supplied and the signal power.

14. The method as claimed in one of the preceding claims 1 to 13, characterized in that the measured variables are used to determine the pump power output by individual pump lasers, in order to detect variations in the performance data of the pump lasers.

15. The method as claimed in one of the preceding claims 1 to 14, characterized in that the measured variables are used to determine the noise figure of an amplifier (32).

16. The method as claimed in the preceding claim 15, characterized in that in order to determine the noise figure its dependence on the ASE and further parameters such as the signal power is stored by one or more functions and/or tables.

17. A computer program with program code means for the purpose of carrying out all the steps in accordance with one of the preceding claims 1 to 16 when the program is run on a computer (22) or microprocessor.

18. The computer program with program code means as claimed in the preceding claim 17 that is stored on a computer-readable data medium.

19. A transmission of a computer program as claimed in the preceding claim 17 on an at least partially electronic path between a transmitter (1) and a receiver (4).

20. The use of a computer program as claimed in the preceding claim 17.

21. An optical isolator (=optical diode) for detecting an ASE in a data transmission and/or amplification path, having an input (6), an output (7) and means (8.1, 8.2), arranged therebetween, that are suitable, inter alia, to couple out backward-directed light, characterized in that a means is provided for detecting the backward-directed light.

22. The optical isolator as claimed in the preceding claim 21, characterized in that the means (8.1, 8.2) arranged between the input (6) and output (7) effect an expansion of the light beam, light running from the input (6) to the output (7) being focused onto the output (7), while light running from the output (7) to the input (6) is not focused onto the input (6).

23. The optical isolator as claimed in the preceding claim 22, characterized in that the means arranged between the input (6) and output (7) include two GRIN lenses (8.1, 8.2) with an arrangement, lying therebetween, consisting of two polarizers (10.1, 10.2) and a Faraday rotator (9).

24. The optical isolator as claimed in one of the preceding claims 21 to 23, characterized in that the means (12) for detecting the backward-directed light is a photodiode.

25. An arrangement for detecting an ASE in an optical data transmission and/or amplification path, having an input (6) and an output (7) for light with optical data signals to be transmitted, characterized in that at least one frequency divider (15) and a detector (12) are provided between the input (6) and output (7), at least one frequency range without data signals being coupled out and supplied to the detector (12).

26. An optical data transmission system between a receiver (4) and a transmitter (1), having a means for controlling an optical gain of a medium (26) with an amplifying effect, the medium (26) with an amplifying effect being fed energy on an optical or electrical path and effecting an amplification of a light signal that traverses the medium, characterized in that means are provided for measuring the intensity of an amplified spontaneous emission (ASE) of the light in the medium (26), and means are provided that initiate, as a function of the intensity of the ASE, a procedure that is related to the gain of the medium (26) or to the structure containing the latter.

27. The optical data transmission system as claimed in the preceding claim 26, characterized in that the medium with an amplifying effect is an optical conductor (26) or a semiconductor amplifier.

28. The optical data transmission system as claimed in the preceding claim 27, characterized in that the optical conductor is an optical fiber (26) or a waveguide structure on a substrate.

29. The optical data transmission system as claimed in one of the preceding claims 26 to 28, characterized in that the medium (26) with an amplifying effect is doped with at least one element of the rare earths, preferably with erbium.

30. The optical data transmission system as claimed in one of the preceding claims 26 to 29, characterized in that forward-directed and/or backward-directed light is coupled out by a coupler upon detection of the amplified spontaneous emission (ASE).

31. The optical data transmission system as claimed in one of the preceding claims 26 to 30, characterized in that a circulator or an isolator, preferably in accordance with one of claims 21 to 24, is provided for coupling out the backward-directed light.

32. The optical data transmission system as claimed in one of the preceding claims 26 to 31, characterized in that upon detection of the amplified spontaneous emission (ASE) provision is made of a frequency-dependent divider, preferably as claimed in claim 25, for the forward- and/or backward-directed light in at least two frequency bands (14.1, 14.2), and a means for measuring the intensity in at least one frequency band (14.1) that is preferably free from data signals.

33. The optical data transmission system as claimed in one of the preceding claims 26 to 32, characterized in that pump lasers with a wavelength in the vicinity of 980 nm and/or 1480 nm is/are provided for the energy supply.

34. The optical data transmission system as claimed in one of the preceding claims 26 to 33, characterized in that the initiated procedure is a control mechanism for the energy supplied.

35. The optical data transmission system as claimed in one of the preceding claims 26 to 34, characterized in that the initiated procedure is a control mechanism for the power of a pumping laser, preferably a 980 nm laser (24).

36. The optical data transmission system as claimed in one of the preceding claims 26 to 35, characterized in that the dependence between actual gain and intensity of the ASE is stored by a function or a table in an electronic memory and evaluated with the aid of a microprocessor (22) in order to determine the gain present.

37. The optical data transmission system as claimed in one of the preceding claims 26 to 36, characterized in that provided as initiated procedure is a monitoring mechanism, preferably in a microprocessor (22), for the reliability performance of an amplifier device or an amplification path.

38. The optical data transmission system as claimed in one of the preceding claims 26 to 37, characterized in that there is provided a means, preferably a microprocessor (22) with an appropriate program, that raises an alarm as a function of the energy supplied and the signal power in the case of a variation in the gain above and/or below a threshold value.

39. The optical data transmission system as claimed in one of the preceding claims 26 to 38, characterized in that there is provided a means, preferably a microprocessor (22) with an appropriate program, which uses the measured variables to determine the pump power output by individual pump lasers, in order to detect variations in the performance data of the pump lasers.

40. The optical data transmission system as claimed in one of the preceding claims 26 to 39, characterized in that there is provided a means, preferably a microprocessor (22) with an appropriate program, which determines the noise figure of an amplifier (32) from the measured variables.
